(19) United States
(12) Patent Application Publication
(10) Pub. No.: US 2008/0162658 A1
(43) Pub. Date: Jul. 3, 2008

(54) Method and System for Presenting a Message During Load Time

(75) Inventor: Erika Reponen, Tampere (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/617,982

(22) Filed: Dec. 29, 2006

(51) Int. Cl. G06F 15/16

(52) U.S. Cl. 709/207

(57) ABSTRACT

A method includes recognizing that load time is occurring in a computing device, calculating the load time, and selecting one or more messages to be presented during the load time.

### BACKGROUND

1. Field

The disclosed embodiments generally relate to computing devices, and in particular to advantageously utilizing the time a computing device may take to complete an operation.

2. Brief Description of Related Developments

When a user is using a computing device such as a personal computer or a mobile device certain operations may take time to complete, causing a user to wait. This load time may vary greatly, from a fraction of a second to at least several minutes. Generally, especially if the load time is estimated to be relatively short, a user may simply wait for the operation to complete.

It would be advantageous to utilize the load time to convey various types of information to a user.

### SUMMARY

In one embodiment, a method includes recognizing that load time is occurring in a computing device, calculating the load time, and selecting one or more messages to be presented during the load time.

In another embodiment, an apparatus includes a mechanism for recognizing that load time is occurring in a computing device, a calculator for determining the load time and a selector for selecting one or more messages to be displayed during the load time.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of a system suitable for practicing the disclosed embodiments;

FIG. 2 shows an illustration of an exemplary mobile device suitable for practicing the disclosed embodiments;

FIG. 3 shows a block diagram of another exemplary mobile device suitable for practicing the disclosed embodiments;

FIG. 4 is a block diagram illustrating the general architecture of the exemplary mobile devices of FIGS. 2 and 3;

FIG. 5 illustrates one example of a schematic diagram of a network in which aspects of the disclosed embodiments may be practiced;

FIG. 6 illustrates a block diagram of an example of an apparatus incorporating features that may be used to practice aspects of the disclosed embodiments;

FIG. 7 shows a flow diagram of a method according to the disclosed embodiments; and

FIGS. 8A-8D show exemplary displays on a user interface according to the disclosed embodiments.

### DETAILED DESCRIPTION

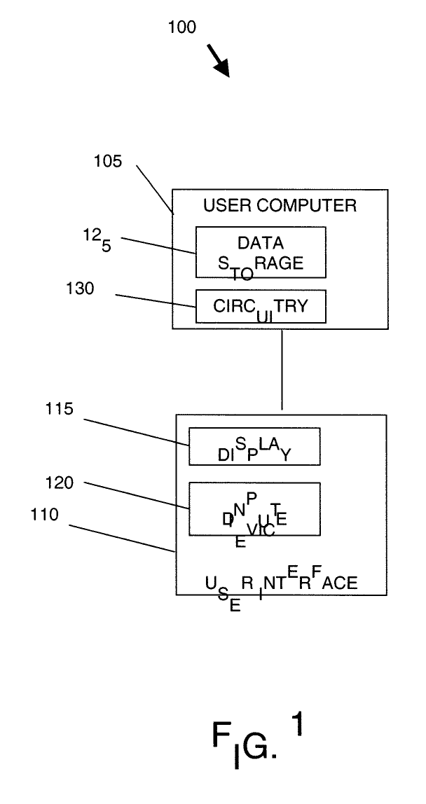

FIG. 1 shows a block diagram of a system 100 suitable for practicing the embodiments disclosed herein. Although the presently disclosed embodiments will be described with reference to the drawings, it should be understood that they may be embodied in many alternate forms. It should also be understood that In addition, any suitable size, shape or type of elements or materials could be used.

The disclosed embodiments are generally directed to presenting information in the form of a message while a user waits for an operation to complete in a computing device. The time to complete the operation may be estimated and information to be communicated may be selected and presented while the operation completes. Exemplary operations that may cause “load time” may include, for example, rendering a web page or an image, loading a new program or application, initializing an application, or computations being performed by an application. For purposes of the disclosed embodiments, any time a user may be waiting for a computing device to complete any operation, or any time a computing device may be occupied with a task may be referred to as load time.

The message presented may not be limited to any particular form or type of information and may include for example, an advertisement or any type of suitable communication. The message may be selected from any suitable source, for example, a database or a repository designated for storing messages.

The system 100 in FIG. 1 is embodied as a computer system including a user computer 105 having a user interface 110 including a display 115 and an input device 120. User computer 105 may also have data storage 125 for storing machine readable program source code which is adapted to cause user computer 105 to perform the operations and methods disclosed herein. User computer 105 may also have circuitry 130 for performing various functions in hardware.

As mentioned above, there may be times when a user of computer 105 may have to wait for an operation to complete, for example, during rendering operations, when loading new programs, when the computer 105 is initializing, when a program is initializing for use, or when a program is performing computations. Computer 105 is generally equipped to recognize when load time is occurring. Load time may be identified, for example, by a lack of display activity during a period of time while an application is running, a spike in processor usage, a dialog box displayed by an application, or by some other criteria. Computer 105 may have routines included in the machine readable program source in data storage 125 for recognizing load time, or may Alternately, computer 105 may utilize circuitry 130 as a mechanism to identify load time, or a combination of routines and circuitry 130 for recognizing load time.

Computer 105 may be able to estimate how long the load time may be, for example, by comparing processor activity with the number and type of operations to complete. Computer 105 may have calculation or calculator routines included in the machine readable program source in data storage 125 for these purposes. Alternately, computer 105 may utilize circuitry 130 as a calculator, or a combination of routines and circuitry 130 for recognizing and estimating the load time.

When computer 105 recognizes that load time is occurring, one or more messages may be selected for presentation to the user. The messages may be selected from a number of different choices stored in data storage 125. The selected message may include a static display, for example, a single screen of non-moving text, images or both, or a dynamic display, such as a scrolling display, a video or a multimedia presentation. The selected message may be also presented in any suitable combination of static or dynamic formats. If the selected message includes a visual presentation, the message may partially occupy display 115 or may occupy the entire display. The message may also include an audio presentation or any other suitable presentation. Computer 105 may have a selector or selection routine included in the machine readable program source in data storage 125. In another embodiment, the selector may be included as part of circuitry 130, or as a combination of routines and circuitry 130.

In one embodiment, the message may include one or more advertisements. The advertisements may be selected according to various criteria including for example, the estimated load time. Other criteria may include those specified by a vendor for placement of the advertisement. In addition, the advertisements may be targeted, that is, selected according to previous activities of the user, for example, browsing history, key words used in searches, applications run, files or content viewed or listened to, etc. In other embodiments the advertisements may be selected at random. In still other embodiments, the advertisements may be selected dynamically when the load time is estimated using one or more predetermined criteria. For example, once the load time has been estimated, the selector may be preprogrammed to weight a subset of exemplary criteria, and select a number of advertisements that meet the weighted criteria for presentation. The exemplary criteria may include any of the criteria described herein and any other suitable selection criteria.

Other types of messages may also be presented. For example, a user may specify particular information that may be presented during load times. The presentation could also include messages from a corporate entity or personal messages from other individuals. If the load time is related to an application starting or performing calculations, messages related to the particular application may be displayed, such as hints or tips. Alternately, news headlines may be displayed. It should be understood that the message presented may include any suitable content presented in any suitable manner.

Computer 105 may use various selection criteria for selecting one or messages for presentation. For example, messages may selected randomly. As another example, messages may be selected in order, one after the other. Alternately, the computer 105 may select messages according to preferences predetermined by the user. Other selection criteria may also be utilized. In one embodiment, computer 105 may analyze the load time estimate to make determinations regarding the message. For example, if the estimated load time is shorter than the time required to retrieve and present a message, computer 105 may not initiate presentation of any message. As another example, computer 105 may select a message to be displayed if there is any load time at all. In this example, the message presentation may be terminated when the load time ends or may be allowed to continue until the presentation completes. As a further example, computer 105 may select a message to be displayed that is static or will that complete its presentation before the estimated load time concludes. In another embodiment, a user may have an option to disable or terminate the message presentation before completion. Similar to other features, computer 105 may have termination calculator routines included in the machine readable program source in data storage 125 for these purposes. Alternately, computer 105 may utilize circuitry 130 as a termination device for performing termination operations.

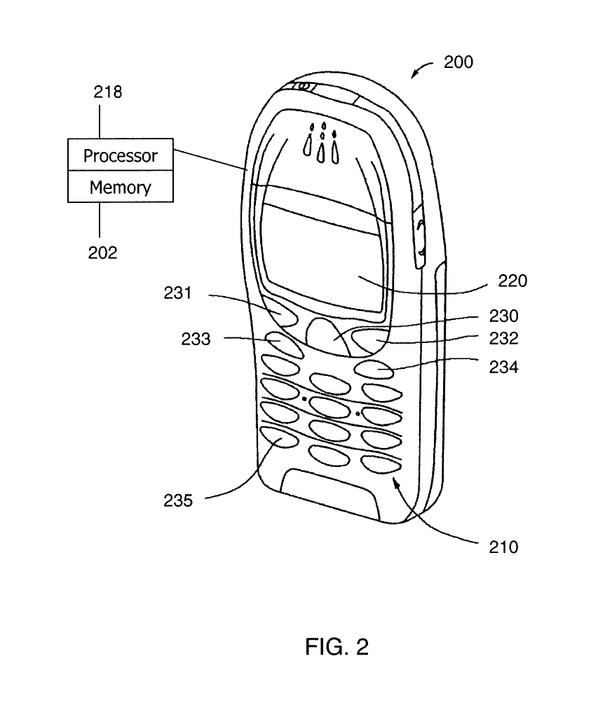

FIG. 2 illustrates another system suitable for practicing the disclosed embodiments. The system of FIG. 2 is embodied as a mobile terminal or communications device 200. The terminal or mobile communications device 200 may have a keypad 210 and a display 220. The keypad 210 may include any suitable user input devices such as, for example, a multi-function/scroll key 230, soft keys 231, 232, a call key 233 and end call key 234 and alphanumeric keys 235. The display 220 may be any suitable display, such as for example, a touch screen display or graphical user interface. The display may be integral to the mobile communications device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display.

The mobile communications device 200 may also include other suitable features such as, for example, a camera, loud speaker, connectivity port or tactile feedback features. The mobile communications device 200 may have a processor 218 for coordinating the operations of the mobile communications device and for processing user inputs and displaying information on the display 220. A memory 202 may be connected to the processor 218 for storing machine readable program source code adapted to cause device 200 to perform the operations and methods disclosed herein. Memory 202 may also store any suitable information, applications, or programs associated with the mobile communications device 200 such as phone book entries, calendar entries, a web browser, an e-mail client, etc.

Similar to the operations of user computer 105 above, a user of mobile communications device 200 may experience load time, for example, when mobile communications device 200 is initializing, loading additional applications, when an application is initializing; or performing computations. Mobile communications device 200 may be configured to recognize when load time is occurring, estimate how long the load time may be, and select one or more messages to be presented on display 220 as described above with respect to user computer 105.

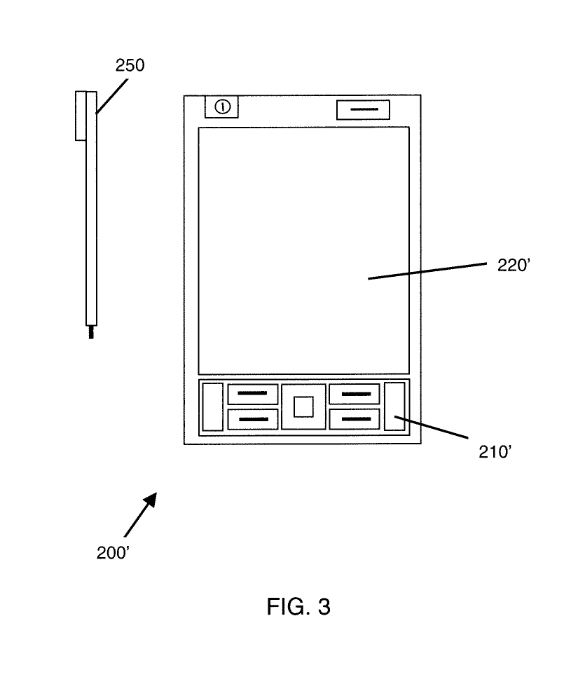

Another system suitable for practicing the disclosed embodiments may be embodied as a PDA style device 200′ illustrated in FIG. 3. The PDA 200′ may have a keypad 210′, a touch screen display 220′ and a pointing device 250 for use on the touch screen display 220′. In still other alternate embodiments, the device may be a personal communicator, a tablet computer, a laptop or desktop computer, a television or television set top box or any other suitable device capable of containing the display 220 and supported electronics such as the processor 201 and memory 202.

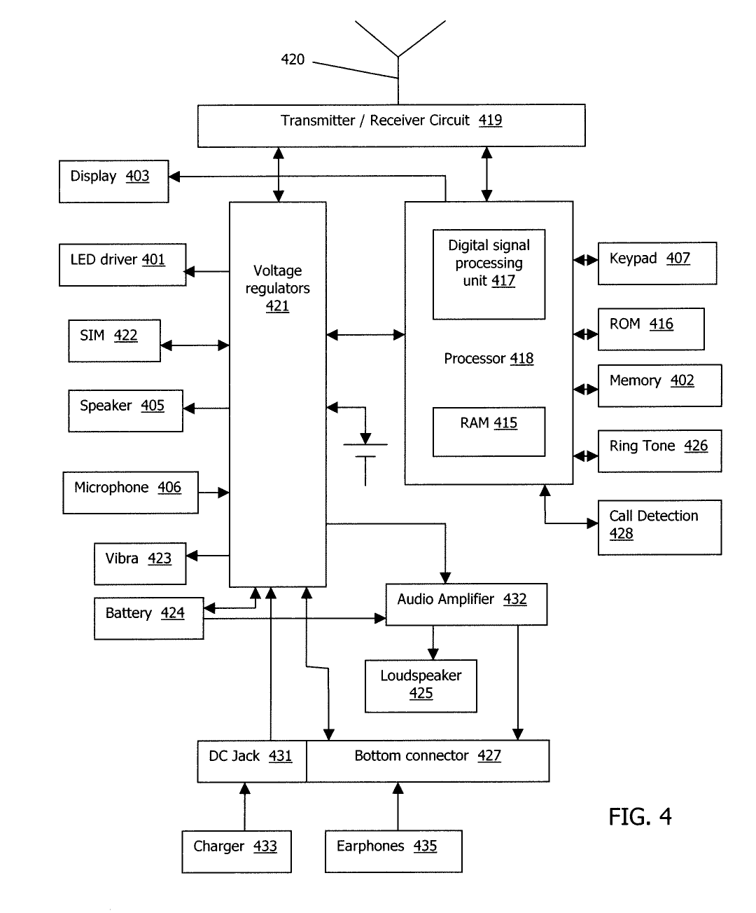

FIG. 4 illustrates in block diagram form one embodiment of a general architecture of the mobile devices 200, 200′. The mobile communications device 200, 200′ may have a processor 418 for controlling the operations of the mobile device, processing user inputs, and displaying information on display 403. The processor 418 may include an integrated digital signal processor 417 and an integrated RAM 415. The processor 418 controls communication with a wireless network via a transmitter/receiver circuit 419 and an antenna 420.

For voice communication, a microphone 406 is coupled to the processor 418 via voltage regulators 421 that transform the user's speech into analog signals. The analog signals converted to digital signals by an A/D converter (not shown) which are then encoded by the digital signal processor 417 in the processor 418. The encoded speech signal is transferred to the processor 418, which e.g. supports, for example, GSM terminal software. The encoded signals are then transmitted to another device by transmitter/receiver circuit 419. Encoded signals from another device are received by transmitter/receiver circuit 419. Digital signal-processing unit 417 speech-decodes the received signals, which are transferred from the processor 418 to the speaker 405 via a D/A converter (not shown). The speaker then reproduces the sounds from the received signals.

The voltage regulators 421 form the interface for the speaker 405, the microphone 406, the LED drivers 401 (for the LEDS backlighting the keypad 407 and the display 403), the SIM card 422, battery 424, the bottom connector 427, the DC jack 431 (for connecting to the charger 433) and the audio amplifier 432 that drives the (hands-free) loudspeaker 425.

The processor 418 may also include or connect to memory 402 for storing any suitable information and/or applications associated with the mobile communications device 200, 200′ such as phone book entries, calendar entries, etc.

The processor 418 also forms the interface for peripheral units of the device, such as for example, a (Flash) ROM memory 416, the graphical display 403, the keypad 407, a ringing tone selection unit 426, and an incoming call detection unit 428. In alternate embodiments, any suitable peripheral units for the device 200, 200′ can be included.

The software in the RAM 415 and/or in the flash ROM 416 contains instructions for the processor 418 to perform a plurality of different applications and functions. In particular, the applications and functions may include the embodiments disclosed herein, including recognizing when load time is occurring and estimating how long the load time may be. The applications and functions may also include selecting one or more messages for presentation to the user during the load time, from a number of different choices stored in RAM 415, ROM 416, or memory 402, as described above with respect to the other devices. In addition, the processor 418 may analyze the load time estimate to make determinations regarding the messages, as described above.

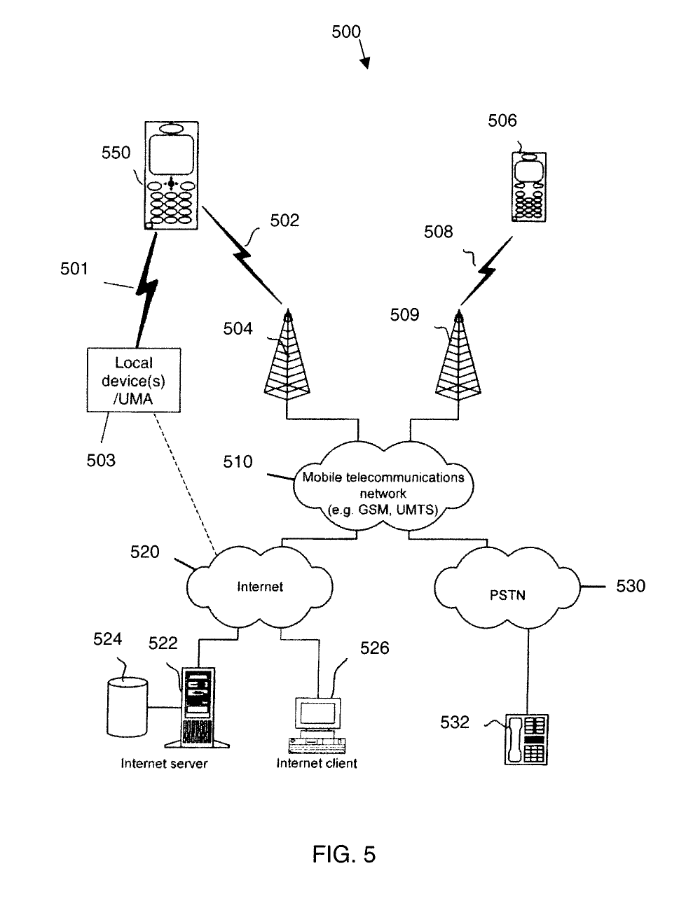

FIG. 5 illustrates an embodiment of a communication system 500 in which the disclosed embodiments may be used. In the communication system 500 of FIG. 5, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 550 and other devices, such as another mobile terminal 506, a stationary telephone 532, or an internet server 522. It is to be noted that for different embodiments of the mobile terminal 550 and in different situations, different ones of the telecommunications services referred to above may or may not be available. The aspects of the disclosed embodiments are not limited to any particular set of services in this respect.

Mobile terminals 550, 506 may be similar to and have the same capabilities as mobile terminals 200, 200′ described above. The mobile terminals 550, 506 may be connected to a mobile telecommunications network 510 through radio frequency (RF) links 502, 508 via base stations 504, 509. The mobile telecommunications network 510 may be in compliance with any commercially available mobile telecommunications standard such as, for example, GSM, UMTS, D-AMPS, CDMA2000, FOMA and TD-SCDMA or other such suitable communication standard or protocol.

The mobile telecommunications network 510 may be operatively connected to a wide area network 520, which may be the Internet or a part thereof. An Internet server 522 has data storage 524 and can be connected to the wide area network 520, as is for example, an internet client computer 526. The server 522 may host a www/wap server capable of serving www/wap content to the mobile terminal 550, 506. In alternate embodiments, the server 522 can host any suitable transaction oriented protocol. For example, a public switched telephone network (PSTN) 530 may be connected to the mobile telecommunications network 510 in a familiar manner. Various telephone terminals, including the stationary telephone 532, may be connected to the PSTN 530.

The mobile terminal 550 may also be capable of communicating locally via a local link 501 to one or more local devices 503. The local link 501 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 503 can, for example, be various sensors that can communicate measurement values to the mobile terminal 500 over the local link 501. The above examples are not intended to be limiting, and any suitable type of link may be utilized. The local devices 503 may be antennas and supporting equipment forming a WLAN implementing Worldwide Interoperability for Microwave Access (WiMAX, IEEE 802.16), WiFi (IEEE 802.11×) or other communication protocols. The WLAN may be connected to the internet. The mobile terminal 550 may thus have multi-radio capability for connecting wirelessly using mobile communications network 510, WLAN or both. Communication with the mobile telecommunications network 510 may also be implemented using WiFi, WiMax, or any other suitable protocols, and such communication may utilize unlicensed portions of the radio spectrum (e.g. unlicensed mobile access (UMA)).

As implemented in any of mobile terminals 550, 506, or Internet client 526, the present embodiments include the capability of recognize when load time is occurring and may be able to estimate how long the load time may be. It should be noted that when implemented in a network system such as system 500, load time may be due to accessing remote information. For example, loading a web page through the Internet 520 may be delayed due to the number of routers or gateways the web page information may have to traverse, or for various other reasons.

When it is recognized that load time is occurring, either due to Internet access or for other reasons, one or more messages may be selected for presentation to the user. The messages may be selected from a number of different choices stored locally in any of mobile terminals 550, 506, or Internet client 526. Alternately, the messages may be stored remotely from the implementing device, for example in data storage 524 connected to Internet server 522. As such, the messages may be accessed by any number of devices for presentation. It should be understood that the messages for presentation during waiting periods may be stored and retrieved from any accessible location in communication system 500.

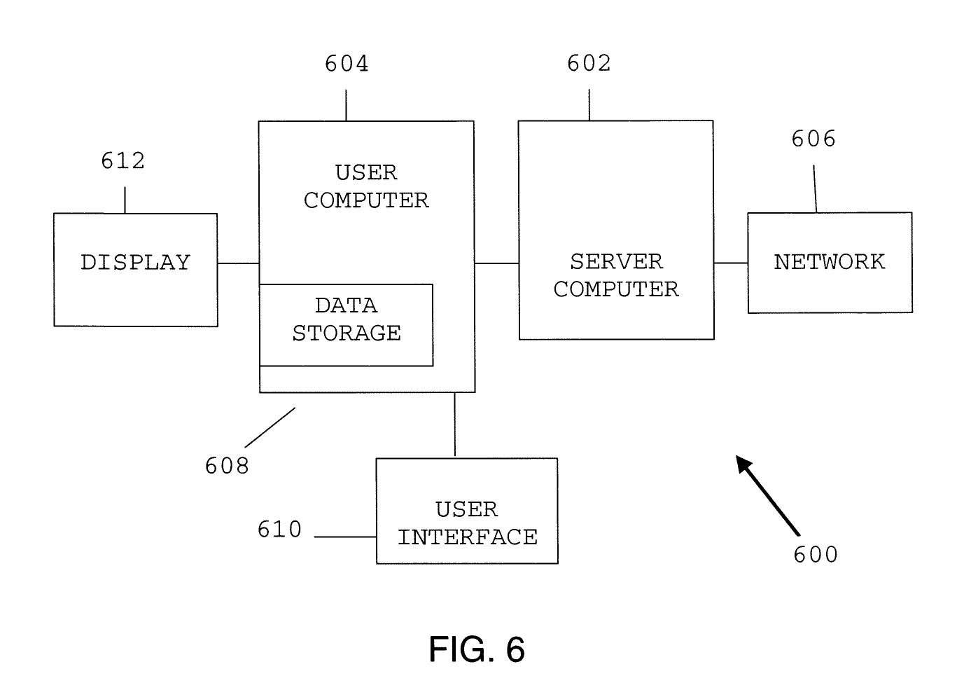

The disclosed embodiments may also include software and computer programs incorporating the process steps and instructions described above that are executed in different computers. FIG. 6 is a block diagram of one embodiment of a typical apparatus 600 incorporating features that may be used to practice aspects of the disclosed embodiments. As shown, a computer system 602 may be linked to another computer system 604, such that the computers 602 and 604 are capable of sending information to each other and receiving information from each other. In one embodiment, computer system 602 could include a server computer adapted to communicate with a network 606. Computer systems 602 and 604 can be linked together in any conventional manner including, for example, a modem, hard wire connection, or fiber optic link. Generally, information can be made available to both computer systems 602 and 604 using a communication protocol typically sent over a communication channel or through a dial-up connection on ISDN line.

Computers 602 and 604 are generally adapted to utilize program storage devices embodying machine readable program source code which is adapted to cause the computers 602 and 604 to perform the method steps disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and methods incorporating aspects of the disclosed embodiments may be stored in one or more computers 602 and 604 on an otherwise conventional program storage device. In one embodiment, computers 602 and 604 may include a user interface 610, and a display interface 612 from which aspects of the disclosed embodiments may be accessed. The user interface 610 and the display interface 612 can be adapted to allow the input of queries and commands to the system, as well as present the results of the commands and queries.

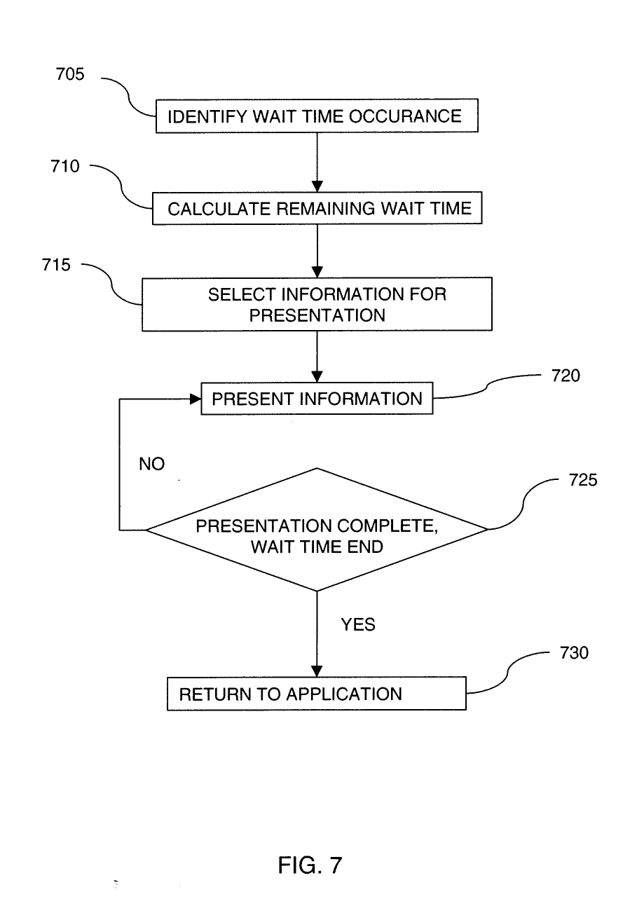

FIG. 7 shows a flow diagram of a method according to the disclosed embodiments. The system 100, 200, 200′, 506, 526, 550 identifies a load time occurrence 705. The system then calculates the remaining load time 710 and selects one or more messages to be presented 715. The messages are presented 720 and a determination is made as to whether the presentation is complete or the load time has ended 725. If not, the presentation continues 720. Otherwise, the presentation terminates and the application returns 730.

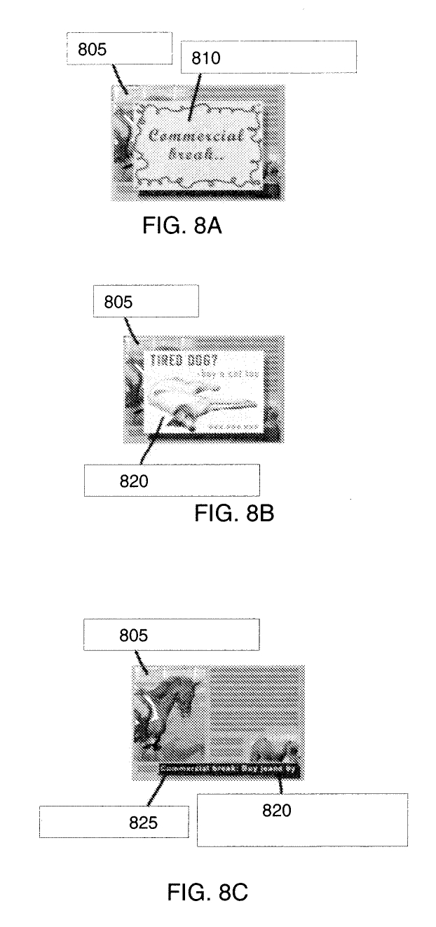

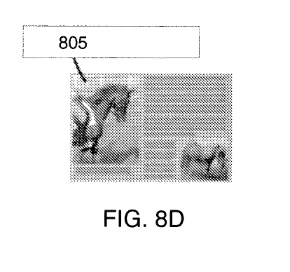

FIGS. 8A-8D show exemplary displays on a user interface of a computer or mobile terminal according to the disclosed embodiments. In FIG. 8A a user has initiated an application, for example, a browser, and has navigated to a web page 805. While the web page is being rendered the system recognizes that load time is occurring and selects one or more messages to be presented to the user. In this example, while the web page is loading the system presents an introductory screen 810 indicating that at least one further message is about to be presented. The presentation begins as shown in FIG. 8B and the selected message 820 for example, an advertisement, is presented to the user. In an alternate embodiment shown in FIG. 8C, the one or more messages 820 may be presented in the form of a progress bar that scrolls the messages. When the web page has finished loading, or when the message presentation is complete, the web page is presented to the user as shown in FIG. 8D.

The disclosed embodiments generally provide information to a user during load time, that is, while the user waits for an operation to complete in a computing device. The embodiments may provide for recognizing when load time occurs, and for determining an estimate of the load time. One or more messages may be selected for presentation using various selection criteria. The load time may be analyzed to make determinations regarding the message.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method comprising:
recognizing that load time is occurring in a computing device;
calculating the load time; and
selecting one or more messages to be presented during the load time.

2. The method of claim 1, wherein the one or more messages include a static display.

3. The method of claim 1, wherein the one or more messages include a dynamic display.

4. The method of claim 1, wherein the one or more messages include an audio presentation.

5. The method of claim 1, further comprising selecting the one or more messages randomly.

6. The method of claim 1, further comprising selecting the one or more messages according to user preferences.

7. The method of claim 1, further comprising selecting the one or more messages according to the load time.

8. The method of claim 1, further comprising selecting the one or more messages from a remote server.

9. The method of claim 1, further comprising:
presenting the selected one or more messages; and
terminating the presentation when the load time ends.

10. An apparatus comprising:
a mechanism for recognizing that load time is occurring in a computing device;
a calculator for determining the load time; and
a selector for selecting one or more messages to be displayed during the load time.

11. The apparatus of claim 10, wherein the one or more messages include a static display.

12. The apparatus of claim 10, wherein the one or more messages include a dynamic display.

13. The apparatus of claim 10, wherein the one or more messages include an audio presentation.

14. The apparatus of claim 10, wherein the selector is configured to select the one or more messages randomly.

15. The apparatus of claim 10, wherein the selector is configured to select the one or more messages according to user preferences.

16. The apparatus of claim 10, wherein the selector is configured to select the one or more messages according to the load time.

17. The apparatus of claim 10, wherein the selector is configured to select the one or more messages from a remote server.

18. The apparatus of claim 10, further comprising:
a user interface for presenting the selected one or more messages; and
a terminating device configured to terminate the presentation when the load time ends.

19. An apparatus comprising:
means for recognizing that load time is occurring in a computing device;
means for determining the load time; and
means for selecting information to be presented during the load time.

20. The apparatus of claim 19, wherein the means for selecting is configured to select the one or more messages randomly.

21. The apparatus of claim 19, wherein the means for selecting is configured to select the one or more messages according to user preferences.

22. The apparatus of claim 19, wherein the means for selecting is configured to select the one or more messages according to the load time.

23. The apparatus of claim 19, further comprising:
a user interface means presenting the selected one or more messages; and
a terminating means configured to terminate the presentation when the load time ends.

24. A user interface comprising:
a display connected to a computing device for presenting an application to a user, the computing device configured to calculate a load time of the application; and
one or more messages selected by the computing device and presented to a user during the load time.

25. The user interface of claim 24, wherein the one or more messages include an introductory screen indicating that at least one further message is about to be presented.

26. The user interface of claim 24, further comprising a progress bar for displaying the one or more messages.

27. The user interface of claim 24, wherein the computing device is configured to select the one or more messages randomly.

28. The user interface of claim 24, wherein the computing device is configured to select the one or more messages according to user preferences.

29. The user interface of claim 24, wherein the computing device is configured to select the one or more messages according to the load time.

31. A computer program product comprising:
a computer useable medium having computer readable code means embodied therein for causing a computer to present information, the computer readable code means in the computer program product comprising:
computer readable program code means for recognizing that load time is occurring in a computing device;
computer readable program code means for calculating the load time; and
computer readable program code means for causing a computer to select one or more messages to be presented during the load time.

32. The computer program product of claim 31, further comprising computer readable program code means for selecting the one or more messages randomly.

33. The computer program product of claim 31, further comprising computer readable program code means for selecting the one or more messages according to user preferences.

34. The computer program product of claim 31, further comprising computer readable program code means for selecting the one or more messages according to the load time.

35. A method comprising:
recognizing the load time is occurring in a computing device;
calculating the load time; and
dynamically selecting one or more advertisements to be presented during the load time according to one or more predetermined criteria.

36. The method of claim 35, wherein the predetermined criteria include previous activities of a user.
